(19) United States
(12) Patent Application Publication
(10) Pub. No.: US 2026/0024317 A1
(43) Pub. Date: Jan. 22, 2026

(54) DISTILLING VISION FOUNDATION MODELS FOR ROBOT LEARNING

(71) Applicant: Boston Dynamics AI Institute LLC, Cambridge, MA (US)

(72) Inventors: Jinghuan Shang, Cambridge, MA (US); Karl Schmeckpeper, Cambridge, MA (US); Brandon Barton May, North Chelmsford, MA (US); Laura Vogelaar Herlant, Arlington, MA (US)

(21) Appl. No.: 19/232,371

(22) Filed: Jun. 9, 2025

Related U.S. Application Data
(60) Provisional application No. 63/673,621, filed on Jul. 19, 2024.

(51) Int. Cl. G06V 10/774; G06V 10/72; G06V 10/77; G06V 10/82

(52) U.S. Cl. CPC G06V 10/774; G06V 10/72; G06V 10/7715; G06V 10/82

(57) ABSTRACT

Images are received by an AI based vision foundation model (VFM) as input. Encoded tokens are generated using the received images by a first component of the AI based VFM. Each encoded token includes a spatial token corresponds to a respective image patch of a set of image patches of at least one image. Additional encoded tokens are extracted from a set of additional AI based VFMs by a second component of the AI based VFM. The additional encoded tokens represent visual data specific to at least one of the additional AI based VFM. Each additional AI based VFM is independent of and different from the AI based VFM. Each additional encoded token is matched to a respective encoded token generated by the first component of AI based VFM using the second component of the AI based VFM.

### CROSS-REFERENCE TO RELATED APPLICATIONS

This application claims the benefit under 35 U.S.C. § 119 of U.S. Provisional Application No. 63/673,621 filed on Jul. 19, 2024, entitled “DISTILLING VISION FOUNDATION MODELS FOR ROBOT LEARNING” the entirety of which is hereby incorporated by reference.

### TECHNICAL FIELD

The subject matter described herein relates to artificial intelligence and machine learning, and more particularly to distillation-based training of a vision foundation model for improving the ability of robots to learn and perform downstream tasks.

### BACKGROUND

Vision foundation models (VFMs) are neural network architectures designed to process visual data and extract meaningful features, enabling applications in areas such as robotics, autonomous systems, and computer vision tasks. These models are foundational for understanding and interpreting complex visual environments by encoding visual features into structured representations that can be used for downstream tasks. Vision-based robot policy learning, which learns action policies from visual inputs, requires strong and diverse visual comprehension. These policies involve many implicit vision tasks such as object recognition and semantic grounding, where off-the-shelf VFMs corresponding to some well-defined tasks can be easily found, however, there is no single model for all of vision tasks.

### SUMMARY

This disclosure relates to distilling vision foundation models for robot learning.

An example implementation of the subject matter described within this disclosure is a method with the following features. Several Images are received by an artificial intelligence based vision foundation model as input. Several encoded tokens are generated using the received images by a first component of the artificial intelligence based vision foundation model. Each encoded token includes a spatial token corresponds to a respective image patch of a set of image patches of at least one image. Several additional encoded tokens are extracted from a set of additional artificial intelligence based vision foundation models by a second component of the artificial intelligence based vision foundation model. The additional encoded tokens represent visual data specific to at least one of the additional artificial intelligence based vision foundation model. Each additional artificial intelligence based vision foundation model is independent of and different from the artificial intelligence based vision foundation model. Each additional encoded token is matched to a respective encoded token generated by the first component of artificial intelligence based vision foundation model using the second component of the artificial intelligence based vision foundation model.

The disclosed method can be implemented in a variety of ways. For example, within a system that includes at least one data processor and a non-transitory memory storing instructions for the processor to perform aspects of the method. Alternatively or in addition, the method can be in included non-transitory computer readable memory storing the method as instructions which, when executed by at least one data processor forming part of at least one computing system, causes the at least one data processor to perform operations of the method.

Aspects of the example method, that can be combined with the example method alone or in combination with other aspects, can include the following. The first component of the artificial intelligence based vision foundation model includes a visual encoder. The second component of the artificial intelligence based vision foundation model includes a feature translator.

Aspects of the example method, that can be combined with the example method alone or in combination with other aspects, can include the following. Several additional artificial intelligence based vision models includes one or more of a CLIP model, DINOv2 model, and SAM model.

Aspects of the example method, that can be combined with the example method alone or in combination with other aspects, can include the following. The mapping of each additional encoded token to the respective encoded token is based on a combination of a cosine loss function and smooth-L1 loss function.

Aspects of the example method, that can be combined with the example method alone or in combination with other aspects, can include the following. A normalization operation is performed on each additional encoded token specific to the at least one additional artificial intelligence based vision foundation model.

Aspects of the example method, that can be combined with the example method alone or in combination with other aspects, can include the following. One or more aspects of the visual data represented by the additional encoded tokens is distilled in responsive to the mapping as part of the first component of the artificial intelligence based vision foundation model using the second component of the artificial intelligence based vision foundation model.

Aspects of the example method, that can be combined with the example method alone or in combination with other aspects, can include the following. Generating the encoded tokens corresponding to the spatial tokens includes the following steps. An initial set of encoded tokens representing multiple initial target image patches of at least one image is generated by the artificial intelligence based vision foundation model. The initial set of encoded tokens includes spatial tokens and several CLS tokens. The initial set of encoded tokens is then filtered by selecting the spatial tokens independent of the CLS tokens using the artificial intelligence based vision foundation model.

### BRIEF DESCRIPTION OF DRAWINGS

These and other features will be more readily understood from the following detailed description taken in conjunction with the accompanying drawings.

FIG. 1 illustrate a flowchart of an example method that can be used with aspects of this disclosure;

FIG. 2 depicts a combination of real-world and simulated tasks utilized as part of the generating, training, and testing of the compact AI based VFM of the present disclosure, according to some aspects described and illustrated herein;

FIG. 3 illustrates a compact AI based VFM generated from different larger VFMs, according to some aspects described and illustrated herein;

FIG. 4 depicts an architecture for generating the compact AI based VFM of the present disclosure, according to some aspects described and illustrated herein;

FIG. 5 illustrates a comparison of outputs from the compact AI based VFM model of the present disclosure as compared to the output from various additional VFMs;

FIG. 6 depicts the performance of the compact AI based VFM model as compared to various additional VFMs;

FIG. 7 depicts the performance of the compact AI based VFM model as compared to various large VFMs;

FIG. 8 depicts correlations between feature norm distribution entropy and robot learning performance, in addition to visualizations of spatial token feature norms from prior models and the compact AI based VFM; and

FIG. 9 illustrates a schematic diagram of an example computing system that can be used with aspects of this disclosure.

### DETAILED DESCRIPTION

Certain implementations will now be described to provide an overall understanding of the principles of the structure, function, manufacture, and use of the devices and methods disclosed herein. One or more examples of these implementations are illustrated in the accompanying drawings. Those skilled in the art will understand that the devices and methods specifically described herein and illustrated in the accompanying drawings are non-limiting implementations and that the scope of the present invention is defined solely by the claims. The features illustrated or described in connection with one implementation may be combined with the features of other implementations. Such modifications and variations are intended to be included within the scope of the present invention.

Further, in the present disclosure, like-named components of the implementations generally have similar features, and thus within a particular implementation each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Sizes and shapes of the systems and devices, and the components thereof, can depend at least on the anatomy of the subject in which the systems and devices will be used, the size and shape of components with which the systems and devices will be used, and the methods and procedures in which the systems and devices will be used.

VFMs such as CLIP, VIT, and DINOv2, tend to underperform as compared to VFMs that are customized for or dedicated to perform specific tasks, e.g., in robot learning. However, VFMs that are customized for performing specific tasks, by definition, lack the ability to be applied to a wide range of tasks that facilitate robot learning. Some efforts to improve the universality or general applicability of VFMs involve improving training data and designing objective functions. But these efforts have yielded mixed results. To address these deficiencies, a single VFM operable to facilitate robot learning across a much wide range of visual tasks is contemplated. To this end, the present disclosure describes an AI based VFM model that distills the capabilities and aspects of a number of large VFMs into a more compact VFM model that is both computationally efficient and inexpensive to train.

The compact AI based VFM model of the present disclosure is smaller and faster (computationally more efficient) than one or more VFMs from which it is generated, and outputs visual representations that are of a higher quality than the VFMs from which it is generated. In other words, the compact AI based VFM model performs better than the VFMs from which it is generated. The distillation technique described herein is applied to the architecture of the compact AI based VFM model. An advantage of the compact AI based VFM is that it can be trained using a smaller dataset while achieving performance that is equal to or better than the larger VFMs from it is generated. Further, when generating this compact model, a set of model weights from a specific set of pretrained VFMs are utilized to ensure effective training of the compact model, thereby enabling improvement in the ability of robots to learn and perform downstream tasks.

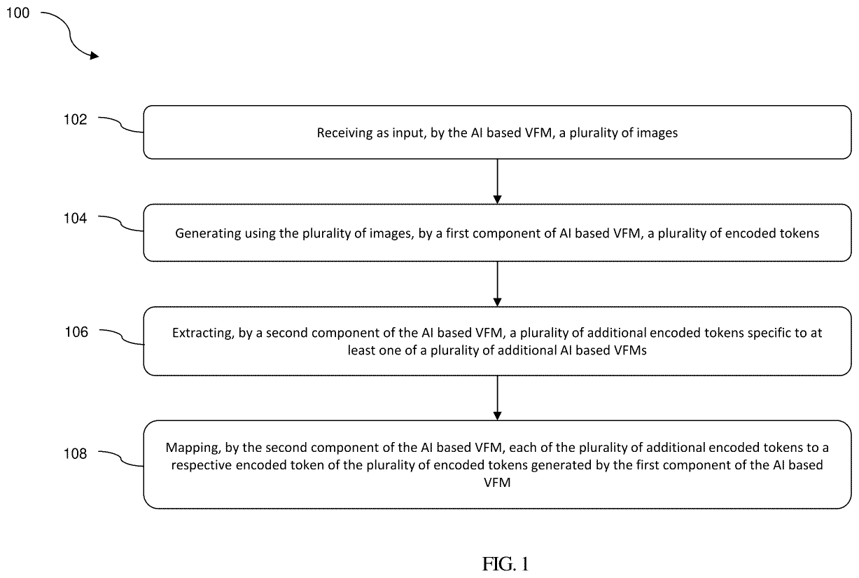

FIG. 1 is a flow chart of an example method 100 that can be used with aspects of this disclosure. At 102, multiple images are received by the AI based VFM as inputs. In some implementations, inputs include a training dataset containing a collection of visual data. The training dataset can include a diverse set of images representing different visual scenarios or tasks. Images may include natural images (e.g., photos captured in real-world settings), annotated images (e.g., images labeled with metadata such as bounding boxes, segmentation masks, or highlighted specific features or regions of interest), or computer-generated visuals (e.g., synthetic images including 3D renderings designed to simulate real-world conditions).

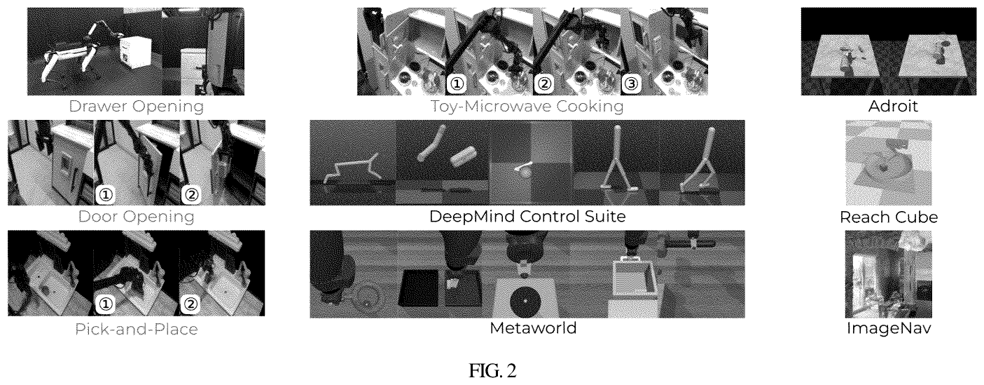

For example, FIG. 2 depicts a combination of real-world and simulated tasks that are utilized as part of the generating, training, and testing of the AI based VFM of the present disclosure, according to some aspects described and illustrated herein. As shown, the real-world tasks include drawer/door opening, picking up an object and placing it at a particular location, and cooking in a toy microwave. Alternatively or in addition, the training dataset includes the ImageNet dataset. In some cases, received images are augmented using methods such as flipping, cropping, resizing, or applying filters to simulate different conditions. In some implementations, images are processed in batches. Batch sizes may vary dependent on the computational resources available and the specific architecture of the AI based VFM; for instance, a batch size of 16 images per GPU is utilized in a distributed training setup with 8 GPUs as described in further detail below.

At 104, multiple encoded tokens are generated by a first component of the AI based VFM using the received images. In some implementations, the first component of the AI based VFM includes a visual encoder. The visual encoder includes a neural network module configured to process visual data and extract high-dimensional features that represent meaningful aspects of the input images. An Encoded token, as described herein, refers to a compact data structure representing one or more image patches associated with one or more images, such as textures, edges, shapes, colors, and other visual features in a format suitable for any downstream tasks as described herein, such as classification, segmentation, or object recognition. Each image patch includes an extracted, small, fixed-size region of an image, for example, parts of an object or a segment of a landscape. The encoded token generated by the visual encoder includes a spatial token i.e., a piece of translated raw image data with spatial relationships in the image preserved in a machine-readable format.

In some implementations, each image is divided into smaller, non-overlapping rectangular regions. For instance, a 224×244 pixels image may be divided into 196 image patches of size 16×16 pixels each. Each image patch is flattened into a one-dimensional vector. The vector is then projected into a higher-dimensional space using the visual encoder, specifically, by a linear embedding layer, to provide an initial representation of the patch. Positional encoding can be added to each patch's representation to retain spatial information about where the patch is located in the original image and a sequence where each patch embedding incorporates information from other patches can be outputted via a transformer layer. In such implementations, visual encoder includes a vision transformer (ViT). To this end, visual encoder is configured to generate a student representation for the input visual data.

Alternatively, or in addition, encoded tokens generated by the visual encoder may include classify (CLS) tokens that represent global information about the image. Unlike spatial tokens described herein, which correspond to localized patches of an image, the CLS token is a single token that serves as an aggregated representation of the entire image. Typically, the CLS token includes a trainable parameter initialized at the beginning of the training. It should be noted that the generation of the compact AI based VFM described herein may involve the use of spatial tokens independent of the use of classify (CLS) tokens. Accordingly, generating the encoded tokens includes filtering an initial set of encoded tokens by selecting only the spatial tokens and leave the CLS tokens untouched, providing that spatial tokens are consistently better than using the CLS tokens for robot learning. In some cases, CLS tokens are utilized as register tokens. In some cases, CLS tokens are removed from the register tokens.

At 106, multiple additional encoded tokens specific to at least one additional AI based VFM of a group of additional AI based VFMs are extracted by a second component of the AI based VFM. Each additional AI based VFM within the group is independent of and different from the AI based VFM. In some instances, the group of additional AI based VFMs includes a set of teacher models e.g., pre-trained VFMs, each designed for a set of specific tasks or objectives. Outputs of the additional AI based VFMs (i.e., the additional encoded tokens) encapsulate specialized visual features or semantic understanding inherent to each teacher model's pre-training objectives. For example, a first additional AI based VFM trained on image-text alignment (e.g., CLIP) may generate tokens encoding semantic associations between objects and textual descriptions, and a second additional AI based VFM trained for depth estimation (e.g., Depth-Anything) may generate tokens encoding spatial depth information for each region of the image.

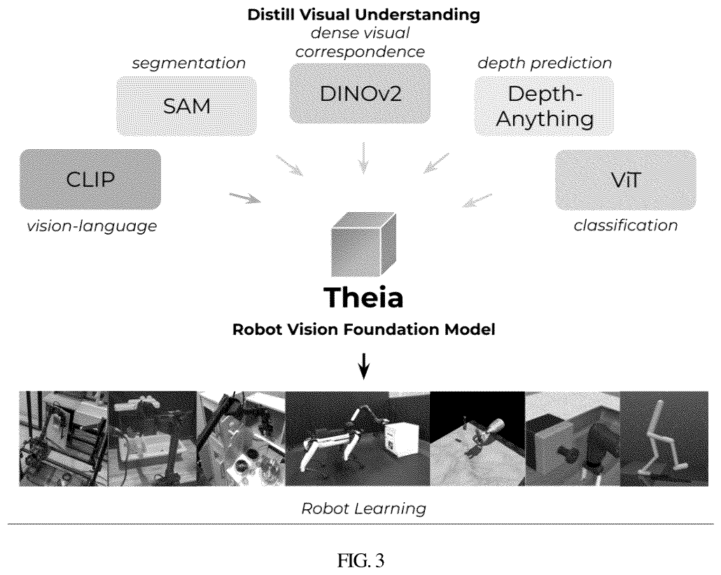

In practice, as shown in FIG. 3, by extracting and leveraging additional encoded tokens from different teacher models, the compact AI based VFM gains access to rich and varied visual representation, improving its ability to generalize across a variety of tasks and domains, integrate complementary visual information, and overcome limitations of any single teacher model. Additionally, this new model enables robots to perform various tasks with a high level of accuracy while enhancing downstream robot learning. Further, this new model reduces training costs and improves computational efficiency associated with downstream robot learning. Exemplary teacher models include CLIP (for vision and language analysis), SAM (for segmentation), DINOv2 (for dense visual correspondence analysis), Depth-Anything (for depth prediction) and ViT (for classification).

The extraction is done through one or more feature translators. In some implementations, the second component of the AI based VFM include a set to feature translators. Each feature translator is paired with an additional AI based VFM. The set of feature translators is configured to extract teacher representations hᵢ(x) of additional AI based VFMs at their respective output layer (for CLIP, VIT, and DINOv2) or before the decoders (for SAM and Depth-Anything). For example, each feature translator includes a shallow Convolution Neural Network (CNN) with a linear layer appended at the end to match the dimension of the corresponding teacher representation. It should be noted that pure linear transforms may not be able to map encoded token (spatial token) to all additional encoded token, resulting in a failure of learning. Accordingly, the CNN includes three CNN layers to account for the fact that each teacher model's representations are significantly different from one another.

For example, each feature translator includes a series of convolutional and linear layers, configured differently based on the input and output token sizes of the student and teacher models, as shown in the tables 1-2 below:

TABLE 1
Configuration 1: Student dₛ × 14 × 14 to Teacher
dₜ × 16 × 16 (CLIP, DINOv2, and ViT)

ConvTranspose2d (dₛ, dₛ, kernel_size = 3, stride = 1, output_padding = 0)
LayerNorm
Conv2d (dₛ, dₛ, kernel_size = 3, padding = 1)
ReLU + LayerNorm
Conv2d (dₛ, dₛ, kernel_size = 3, padding = 1)
ReLU + LayerNorm
Flatten and Linear (dₛ, dₜ)

TABLE 2
Configuration 2: Student dₛ × 14 × 14 to Teacher
dₜ × 64 × 64 (SAM and Depth-Anything)

ConvTranspose2d (dₛ, dₛ, kernel_size = 3, stride = 2, padding = 1)
LayerNorm
ConvTranspose2d (dₛ, dₛ, kernel_size = 3, stride = 2, output_padding = 1)
ReLU + LayerNorm
Conv2d (dₛ, dₛ, kernel_size = 3, padding = 1)
ReLU + LayerNorm
Flatten and Linear (dₛ, dₜ)

In cases where multiple additional encoded tokens specific to more than one additional AI based VFMs are generated, for example, a first additional AI based VFM, such as CLIP may output tokens representing image-text embeddings, while a second additional AI based VFM, such as DINOv2 may output spatially dense tokens used for object detection, a normalization operation is performed on each additional encoded token to accommodate different scales. The normalization operation can scale the loss of different teacher features evenly and avoid biasing (collapsing) to a teacher model with extremely larger norms. For example, the normalization operation is performed on each additional encoded token over each latent dimension, where mean and variance are calculated from the received images as follows:

$${h ( {\tilde{x}}_{j} )}_{c} = \frac{{h ( {x}_{j} )}_{c} - {μ}_{c}}{{σ}_{c}} , {μ}_{c} = \frac{1}{N} {\sum }_{j} {h ( {x}_{j} )}_{c} , {σ}_{c} = \frac{\sqrt{{\sum }_{j} {( {h ( {x}_{j} )}_{c} - μ )}^{2}}}{N}$$

where c is the channel index for the teacher feature, j is the index of the image, and N is the number of samples of the training dataset.

At 108, each one of the additional encoded tokens is mapped by the second component (feature translator) of the AI based VFM to a respective encoded token generated by the first component of the AI based VFM. In some implementations, feature translators are applied to iteratively align each student representation (encoded tokens) generated by the visual encoder (the first component of the AI based VFM) with the teacher representations (additional encoded tokens). Mapping between teacher and student representations involves distillation of additional encoded tokens. In some instances, distillation is performed to transfer one or more aspects of the visual data represented by the additional encoded tokens into the representations generated by the first component of the AI-based VFM to effectively integrate enriched visual knowledge from additional AI-based VFMs (teacher models) into the compact AI based VFM (student model).

For example, additional knowledge from the teacher models, calculated based on the difference between the student and teacher feature pairs, is used to augment the local feature representation of the AI based VFM. Such mapping is guided by a loss function, for instance, a combination of cosine similarity loss and smooth L1 loss, to minimize the discrepancy between the tokens. The loss function is as follows:

$$L ( x ; θ ) = {\sum }_{i}^{M} {α}_{i} ( β L ( {g}_{i} ( f ( x ) ) , {h}_{i} ( x ) ) + ( 1 - β ) {L}_{smooth - L 1} ( {g}_{i} ( f ( x ) ) , {h}_{i} ( x ) ) )$$

Where x is the input image, M is the number of additional AI based VFMs (teacher models), αᵢ is the loss weight for each teacher, and B is the weight for balancing cosine loss and smooth L1 loss respectively. In general, αᵢ is set to 1/M such that the loss weights each additional AI based VFM equally, and β is set to 0.9.

Specifically, the AI-based VFM is trained using 8 NVIDIA H100 GPUS, each configured with a batch size of 16 images per GPU, resulting in an effective batch size of 128 images across the system. The training process employs the AdamW optimizer with betas of [0.9, 0.999] to control the exponential decay rates for the moment estimates, and a weight decay value of 0.01 to prevent overfitting. The learning rate (LR) is initialized at 5e-4 and follows a constant LR schedule throughout the training. A warm-up period of 5 epochs is employed, during which the learning rate is gradually increased using a linear warm-up schedule. The AI based VFM is trained for a total of 50 epochs. Gradient clipping and image augmentation can be omitted during the training. The total computational cost of training the AI based VFM is 152 GPU hours.

Alternatively or in addition, the AI-based VFM can be trained using a larger-scale architecture and dataset configuration to further enhance its capabilities on vision tasks, such as complex 3D understanding tasks. In some implementations, the visual encoder is based on ViT-Large (ViT-L) backbone including approximately 307 million parameters, and the training is performed using a substantially larger dataset, such as DataComp-1B dataset containing approximately 1 billion images. In some cases, only a single training epoch is employed due to the scale of the dataset. The teacher model can include different combination of additional AI-based VFMs. For example, the teacher model configuration used during training can include a combination of CLIP, DINOv2, and VIT (CDiV). This configuration can be modified in which ViT is excluded, referred to as CDi (CLIP-L and DINOv2-L).

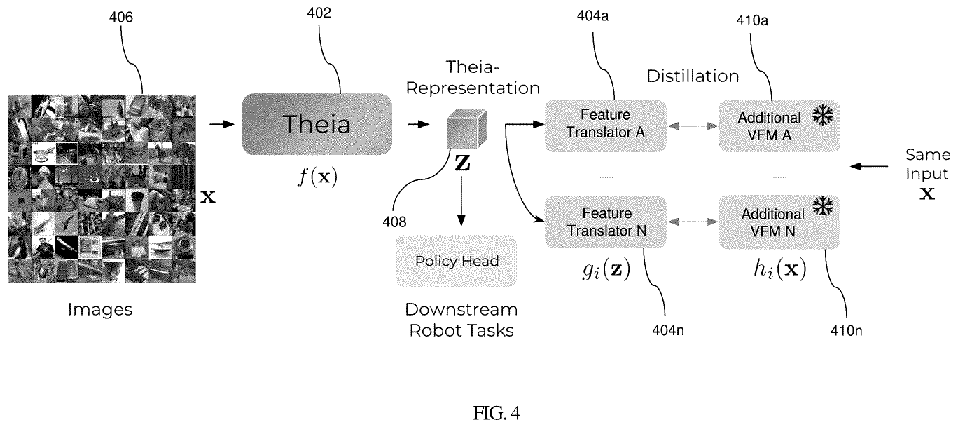

FIG. 4 depicts an architecture for generating the compact AI based VFM of the present disclosure, according to some aspects described and illustrated herein. The architecture includes a visual encoder 402 (f(x)) and a number of feature translators 404a-n (gᵢ(z)). In aspects, an image 406 (x) (or a plurality of images) can serve as input to the visual encoder 402, which outputs robust and rich visual representations 408 (e.g., visual representations that are of high quality, high fidelity, etc.). These visual representations 408 are utilized for enabling robots to better learn and perform various downstream tasks as described herein. The visual representations 408 comprise a set of encoded tokens corresponding to various image patches of the input image (x). In aspects, as part of the generating of the compact AI based VFM of the present disclosure, the encoded tokens comprise spatial tokens because spatial tokens, which represent spatially dense representations, are useful for diverse visual understanding. The generation of the compact AI based VFM described herein may involve the use of spatial tokens independent of the use of classify (CLS) tokens.

Further, each of the features translators 404a-n are operable to supervise the visual representations 408 output by the visual encoder 402. Such supervision involves extracting visual representations of several additional VFMs 410a-n (e.g., larger teacher models, such as CLIP, SAM, and DINOv2, etc.), and mapping these onto the visual representations output 408 by the visual encoder 402. In aspects, each of the extracted visual representations of additional VFMs 410a-n are normalized over each latent dimension, in which average and variance values are calculated from a plurality of training images. Further, the mapping is performed using a combination of a cosine loss function and a smooth-LI loss function as described herein. The loss functions enable the matching of each pair of predicted and ground truth representations for the same image 406. Thereafter, a weighted average of the combination of the two loss functions is calculated.

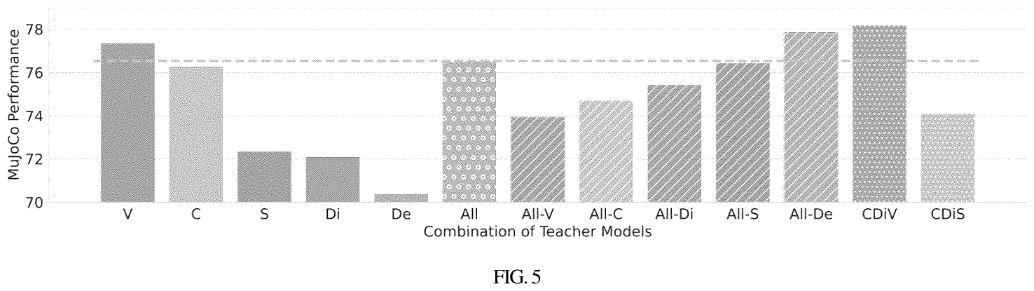

FIG. 5 depicts performance results associated with using various combinations of the large VFMs utilized to generate the compact AI based VFM of the present disclosure, according to some aspects described and illustrated herein. As shown, using all of the additional VFMs, such as ViT (V), CLIP (C), SAM(S), DINOv2 (Di), and Depth-Anything (De), to generate the compact AI based VFM enables the compact AI based VFM to perform better than if four out of the five large VFMs were distilled individually (All-X). As shown in FIG. 5, generating the compact AI based VFM by distilling the CDiV provides the best good performance.

It should be noted that the performance of the compact AI based VFM can be further improved by adjusting model and dataset scale as described above. In particular, by employing ViT-L as visual encoder and training on the much larger DataComp-1B dataset, 3D understanding tasks such as depth estimation, surface normal estimation, multi-view correspondence can be significantly enhanced. For instance, in depth estimation, surface normal estimation, and multi-view correspondence, the compact AI based VFM trained with the VIT-L backbone and CDi teacher model configuration achieved higher average accuracies of 0.9894, 0.7362, and 0.5416, compared to 0.9349, 0.4986, and 0.4870 of the baseline model, respectively.

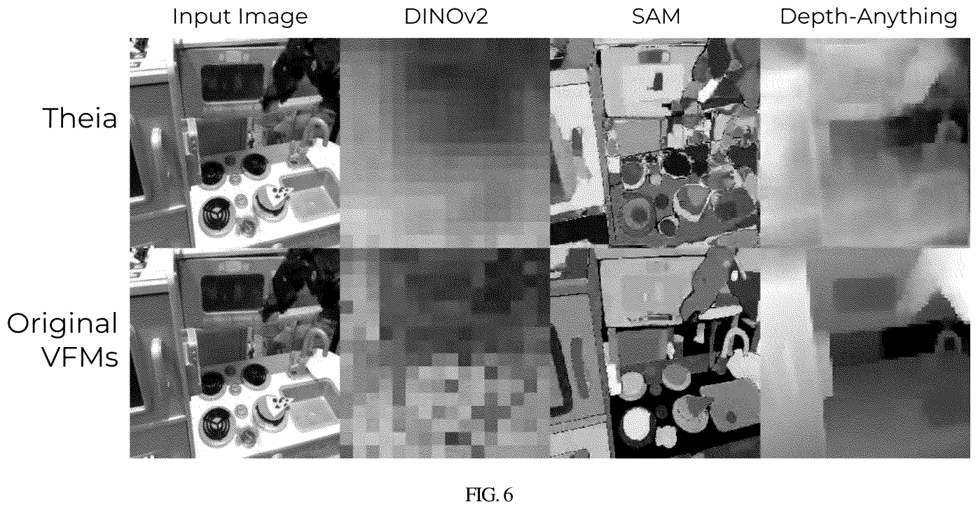

FIG. 6 illustrates a comparison of the visualization of outputs from the compact AI based VFM of the present disclosure (top) as compared to the outputs from various additional VFMs (bottom). Principle component analysis (PCA) is applied for visualizing feature representations output by DINOv2, SAM decoder is used to generate segmentation results, and Depth-Anything head is used to produce an estimated depth. It should be noted that the compact AI based VFM and additional AI based VFMs are not trained on these images. The predicted representation of the compact AI based VFM can be decoded by respective additional AI based VFM and produce reasonable results. As shown, the outputs from the compact AI based VFM are more accurate compared to the outputs from additional AI based VFMs.

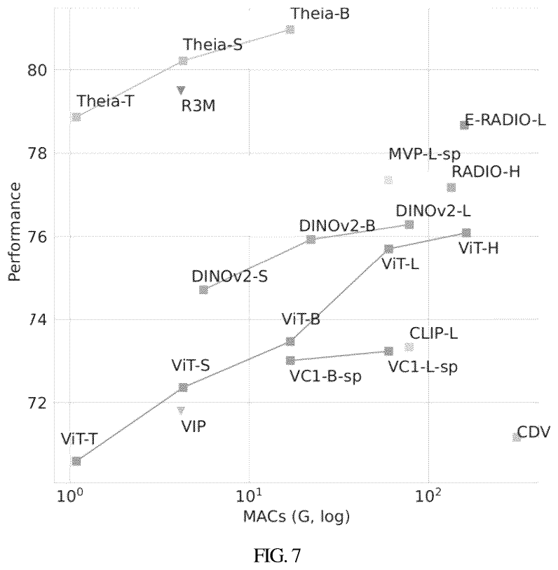

FIG. 7 depicts the performance of the compact AI based VFM model as compared to various large VFMs. As indicated in red, the compact AI based VFM model outperforms all of the other large VFMs.

Referring back to FIG. 1, it should be noted that the visual representations provided by the AI based VFM generated via the disclosed method 100 are designed to encode a diverse range of visual features, including but not limited to semantic, spatial, and contextual information, allowing robots to generalize effectively across various tasks. In addition, the disclosed method 100 enables the AI-based VFM to generate spatial tokens that preserve localized information about target image patches while simultaneously aggregating global context through CLS tokens. To evaluate the quality of visual representations generated by the AI based VFM, norm distribution of encoded tokens is computed, and the entropy of the norm distribution is then calculated as follows:

$$H = - {\sum }_{i} ( {P}_{i} \times log ( {p}_{i} ) )$$

Where pᵢ is the probability of a feature norm falling within a particular range or bin in the distribution, and n is the total number of bins. A higher entropy indicates a broader and more uniform distribution of feature norms, which correlates with richer and more diverse visual representations.

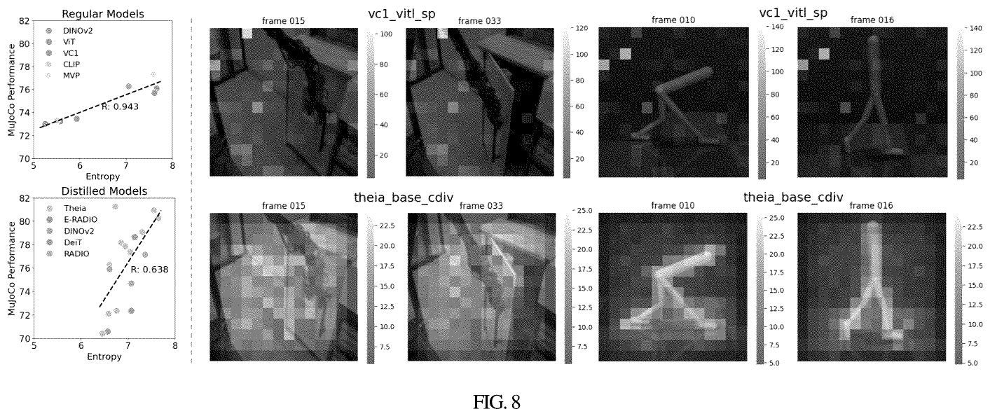

FIG. 8 depicts correlations between feature norm distribution entropy and robot learning performance, in addition to visualizations of spatial token feature norms from prior models and the compact AI based VFM. As shown in FIG. 7, the compact AI based VFM has very few or no outlier tokens, and the tokens with higher norms are more task-relevant even though the compact AI based VFM is not trained on these robot images. In the quantitative analysis as shown in the left of FIG. 7, the distilled models generally have higher entropy and correlation. Other quantitative measurements, such as feature similarity, PCA-explained variance ratios, can be used.

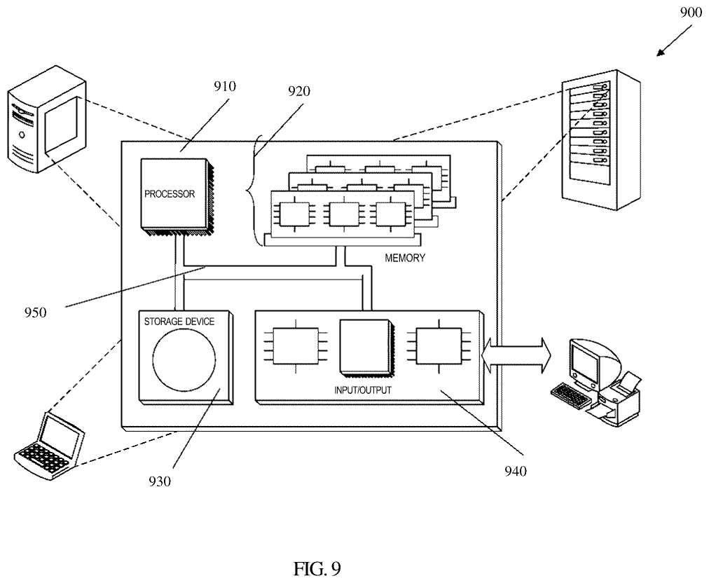

FIG. 9 illustrates a schematic diagram of an example computing system 800 is provided. The example computing system 800 includes a processor 810, a memory 820, a storage device 830, and an input/output device 840. The components 810, 820, 830, 840 are interconnected using a system bus 850. The processor 810 is capable of processing instructions for execution within the example computing system 800. In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840.

The memory 820 stores information within the example computing system 800. In one implementation, the memory 820 is a computer-readable medium. In one implementation, the memory 820 is a volatile memory unit. In another implementation, the memory 820 is a nonvolatile memory unit. The storage device 830 is capable of providing mass storage for the example computing system 800. In one implementation, the storage device 830 is a computer-readable medium. In various different implementations, the storage device 830 can be a floppy disk device, a hard disk device, an optical disk device, or a tape device. The input/output device 840 provides input/output operations for the example computing system 800. In one implementation, the input/output device 840 includes a keyboard and/or pointing device. In another implementation, the input/output device 840 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result.

A computer program can be written in any form of programming language, including compiled or interpreted languages, and it can be deployed in any form, including as a stand-alone program or as a module, component, subroutine, or other unit suitable for use in a computing environment. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other implementations are within the scope of the following claims.

A number of implementations of the present disclosure have been described. Nevertheless, it will be understood that various modifications can be made without departing from the spirit and scope of the present disclosure. Accordingly, other implementations are within the scope of the following claims.

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

1. A method of training an artificial intelligence based vision foundation model, implemented by at least one data processor of a computing device, the method comprising:
receiving as input, by the artificial intelligence based vision foundation model executed by the at least one data processor, a plurality of images;
generating using the plurality of images, by a first component of the artificial intelligence based vision foundation model, a plurality of encoded tokens, each of the plurality of encoded tokens corresponding to a respective image patch of a plurality of image patches of at least one of the plurality of images, the plurality of encoded tokens corresponding to spatial tokens;
extracting, by a second component of the artificial intelligence based vision foundation model, a plurality of additional encoded tokens specific to at least one of a plurality of additional artificial intelligence based vision foundation models, each of the plurality of additional artificial intelligence based vision foundation models being independent of and different from the artificial intelligence based vision foundation model, the plurality of additional encoded tokens representing visual data specific to the at least one of the plurality of additional artificial intelligence based vision foundation models; and
mapping, by the second component of the artificial intelligence based vision foundation model, each of the plurality of additional encoded tokens to a respective encoded token of the plurality of encoded tokens generated by the first component of the artificial intelligence based vision foundation model.

2. The method of claim 1, wherein the first component of the artificial intelligence based vision foundation model comprises a visual encoder.

3. The method of claim 1, wherein the second component of the artificial intelligence based vision foundation model comprises a feature translator.

4. The method of claim 1, wherein the plurality of additional artificial intelligence based vision foundation models includes one or more of a CLIP model, DINOv2 model, and SAM model.

5. The method of claim 1, wherein the mapping of each of the plurality of additional encoded tokens to a respective encoded token of the plurality of encoded tokens is based on a combination of a cosine loss function and smooth-LI loss function.

6. The method of claim 1, further comprising:
performing a normalization operation on each of the plurality of additional encoded tokens specific to at least one of the plurality of additional artificial intelligence based vision foundation models.

7. The method of claim 1, further comprising:
distilling responsive to the mapping, by the second component of the artificial intelligence based vision foundation model, one or more aspects of the visual data represented by the plurality of additional encoded tokens as part of the first component of the artificial intelligence based vision foundation model.

8. The method of claim 1, wherein the generating of the plurality of encoded tokens corresponding to the spatial tokens comprises:
generating, by the artificial intelligence based vision foundation model, an initial set of encoded tokens representing an initial plurality of target image patches of at least one of the plurality of images, the initial set of encoded tokens including the spatial tokens and a plurality of CLS tokens; and
filtering, by the artificial intelligence based vision foundation model, the initial set of encoded tokens.

9. The method of claim 8, wherein the filtering comprising selecting the spatial tokens independent of the plurality of CLS tokens.

10. A system comprising:
at least one data processor of a computing device; and
memory for storing instructions that, when executed by the at least one data processor, perform operations comprising:
receiving as input, by an artificial intelligence based vision foundation model executed by the at least one data processor, a plurality of images;
generating using the plurality of images, by a first component of the artificial intelligence based vision foundation model, a plurality of encoded tokens, each of the plurality of encoded tokens corresponding to a respective image patch of a plurality of image patches of at least one of the plurality of images, the plurality of encoded tokens corresponding to spatial tokens;
extracting, by a second component of the artificial intelligence based vision foundation model, a plurality of additional encoded tokens specific to at least one of a plurality of additional artificial intelligence based vision foundation models, each of the plurality of additional artificial intelligence based vision foundation models being independent of and different from the artificial intelligence based vision foundation model, the plurality of additional encoded tokens representing visual data specific to the at least one of the plurality of additional artificial intelligence based vision foundation models; and
mapping, by the second component of the artificial intelligence based vision foundation model, each of the plurality of additional encoded tokens to a respective encoded token of the plurality of encoded tokens generated by the first component of the artificial intelligence based vision foundation model.

11. The system of claim 10, wherein the first component of the artificial intelligence based vision foundation model comprises a visual encoder.

12. The system of claim 10, wherein the second component of the artificial intelligence based vision model comprises a feature translator.

13. The system of claim 10, wherein the plurality of additional artificial intelligence based vision foundation models includes one or more of a CLIP model, DINOv2 model, and SAM model.

14. The system of claim 10, wherein the mapping of each of the plurality of additional encoded tokens to a respective encoded token of the plurality of encoded tokens is based on a combination of a cosine loss function and smooth-L1 loss function.

15. The system of claim 10, wherein the operations further comprise:
normalizing each of the plurality of additional encoded tokens specific to at least one of the plurality of additional artificial intelligence based vision foundation models.

16. The system of claim 10, wherein the operations further comprise:
distilling responsive to the mapping, by the second component of the artificial intelligence based vision foundation model, one or more aspects of the visual data represented by the plurality of additional encoded tokens as part of the first component of the artificial intelligence based vision foundation model.

17. The system of claim 10, wherein one of the operations of the generating of the plurality of encoded tokens corresponding to the spatial tokens comprises:
generating, by the artificial intelligence based vision foundation model, an initial set of encoded tokens representing an initial plurality of target image patches of at least one of the plurality of images, the initial set of encoded tokens including the spatial tokens and a plurality of CLS tokens; and
filtering, by the artificial intelligence based vision foundation model, the initial set of encoded tokens.

18. The system of claim 17, wherein one of the operations of the filtering of the initial set of encoded tokens comprises selecting the spatial tokens independent of the plurality of CLS tokens.

19. A non-transitory computer readable storage media storing instructions that, when executed by at least one data processor of a computing device, causes the at least one data processor to perform operations comprising:
generating, by the at least one data processor of the computing device, a compact artificial intelligence (AI) based vision foundation model from a plurality of additional AI based vision foundation models, each of the plurality of additional AI based vision foundation models having a different respective visual data analysis capability, the generating including:
receiving a plurality of training images,
generating a plurality of encoded tokens from at least one of the plurality of training images, each encoded token corresponding to a respective image patch of a plurality of image patches forming the at least one of the plurality of training images,
extracting a plurality of additional encoded tokens from one or more images associated with the plurality of additional AI based vision foundation models,
training the plurality of encoded tokens using the plurality of additional encoded tokens of the plurality of additional AI based vision foundation models, the training including mapping each additional encoded token to a respective encoded token of the plurality of encoded tokens associated with the at least one of the plurality of training images, and
distilling, based on the training, one or more of the different respective visual analysis capabilities as part of the compact AI based vision foundation model.

20. The non-transitory computer readable storage media of claim 19, wherein the plurality of additional AI based vision foundation models includes one or more of a CLIP model, DINOv2 model, and SAM model.
